(19) United States
(12) Patent Application Publication
(10) Pub. No.: US 2011/0237421 A1
(43) Pub. Date: Sep. 29, 2011

(54) METHOD AND SYSTEM FOR PRODUCING COATINGS FROM LIQUID FEEDSTOCK USING AXIAL FEED

(75) Inventors: Alan William Burgess, North Vancouver (CA); Philip Maxime Hartell, Mississauga (CA); Christopher S.M. Davidson, Maple Ridge (CA); Zhaolin Tang, Vancouver (CA)

(73) Assignee: NORTHWEST METTECH CORP., North Vancouver, CA (CA)

(21) Appl. No.: 12/991,853

(22) PCT Filed: May 29, 2009
(86) PCT No.: PCT/CA09/00746

§ 371 Date: Jun. 2, 2011

Related U.S. Application Data
(60) Provisional application No. 61/057,184, filed on May 29, 2008.

(51) Int. Cl. C04B 35/48; C23C 26/02; B05D 1/08

(52) U.S. Cl. 501/134; 118/715; 427/446

(57) ABSTRACT

The present invention provides a system for producing coatings on a substrate from a liquid feedstock. The system comprises an axial injection thermal spray torch and a liquid feedstock delivery means for delivering a controlled flow of liquid feedstock to the torch. The torch is provided with a convergent/divergent nozzle.

### CROSS REFERENCE TO RELATED APPLICATION

The present application claims the benefits, under 35 U.S.C. §119(e), of U.S. Provisional Application Ser. No. 61/057,184 filed May 29, 2008 which is incorporated herein by this reference.

### TECHNICAL FIELD

The invention relates to the field of thermal spray coating and more particularly thermal spray coating using liquid feedstock.

### BACKGROUND

Thin and dense coatings are required for coating applications such as solid oxide fuel cells (SOFC's), new thermal barrier coatings applications (TBC's), oxygen transport membranes (OTM's) and next generation environmental barrier coatings (EBC's). These applications present significant challenges for traditional plasma spray. For example, finer powders have been found to yield both denser coatings with thinner lamellae splats when compared to traditionally sized thermal spray powders. However, powders finer than 10 microns (nanopowders) are very difficult to feed consistently into a plasma torch. In the past, feeding issues have prevented standard techniques to produce coatings using powders finer than 10 microns with conventional thermal spray feeding devices.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

By suspending fine nanopowders in liquid or using a liquid precursor and injecting the solid/liquid slurry or precursor into the plasma plume, using a reliable delivery mechanism to spray fine particles, one obtains dense coating structures. Liquid slurries or precursors offer a means to deliver fine particles for thermal spray torches. An automated slurry/precursor feed system and axial injection plasma spray torch are used to spray slurry/precursor based coatings using a convergent/divergent nozzle. The slurries/precursors are injected axially with consistent flow that results in dense coatings.

In particular the invention provides a system for producing coatings on a substrate from a liquid feedstock. The system comprises an axial injection thermal spray torch and a liquid feedstock delivery means for delivering a controlled flow of liquid feedstock to the torch. The torch is provided with a convergent/divergent nozzle which may be a supersonic nozzle. According to one aspect the torch is provided with an atomizer for atomizing the liquid feedstock prior to injection into the plasma stream. According to a further aspect the liquid feedstock is a liquid slurry of suspended nanopowders or a liquid precursor. According to a further aspect the means for delivering a controlled flow of liquid feedstock to the torch comprises an electronic controller in combination with a mass flow meter using a pressurized tank.

The invention further provides a method for producing coatings on a substrate from a liquid feedstock. The method comprises I) providing an axial injection thermal spray torch comprising a convergent/divergent nozzle, and a liquid feedstock delivery means for delivering a controlled flow of liquid feedstock to the torch; ii) delivering a controlled flow of liquid feedstock to the axial injection thermal spray torch and producing a plasma spray of coating particles through the convergent/divergent nozzle onto the substrate. According to one aspect the torch is provided with an atomizer for atomizing the liquid feedstock prior to injection into the plasma stream. According to a further aspect the liquid feedstock is a liquid slurry of suspended nanopowders or a liquid precursor. According to a further aspect the means for delivering a controlled flow of liquid feedstock to the torch comprises an electronic controller in combination with a mass flow meter. In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating the thermal spray system of the invention; and

FIG. 2 is a front view of a convergent/divergent nozzle used in the invention.

FIG. 3 is a cross-section of the convergent/divergent nozzle taken along lines A-A of FIG. 2.

FIG. 4 is a detail cross-section of region B of the convergent/divergent nozzle of FIG. 2.

FIG. 5 is a detail cross-section of region B of a second embodiment of the convergent/divergent nozzle of FIG. 2.

FIG. 6 is a perspective view of the injector tubes and convergence blank of a torch according to one embodiment of the invention.

FIG. 7 is a front view of a convergence blank illustrating a first embodiment of a two fluid injector.

FIG. 8 is a side elevation of the convergence blank shown in FIG. 7.

FIG. 9 is a cross-section view taken along lines A-A of FIG. 8.

FIG. 10 is a detail cross-section view of the atomizer shown in FIG. 9.

FIG. 11 is an isolated detail cross-section view of the atomizer shown in FIG. 9.

FIG. 12 is a cross-section of the injector tubes and convergence blank of a torch according to one embodiment of the invention taken along lines C-C of FIG. 6.

FIG. 13 is a front view of a convergence blank illustrating a liquid injector with increased cooling and no atomization.

FIG. 14 is a side elevation of the convergence blank shown in FIG. 16.

FIG. 15 is a cross-section view taken along lines E-E of FIG. 17.

FIG. 16 is a detail cross-section view of the convergence blank shown in FIG. 18.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Nanopowders are powders composed of particles having a diameter between about 1 and 100 nanometers (10⁻⁹ m. to 10⁻⁷ m). Nanopowders are replacing conventional powders in many applications because of their unique properties, such as higher surface area and easier formability, and because of improved performance of end products. Some current applications of nanopowders are catalysts, lubricants, abrasives, explosives, sunscreen and cosmetics. Micropowders are powders composed of particles having a diameter between about 100 nanometers and 10 microns (10⁻⁷ m. to 10⁻⁵ m). Micropowders encompass submicropowders which have a diameter between about 100 nanometers and 1 micron (10⁻⁷ m. to 10⁻⁶ m). Micropowders also have many useful current applications. The term “nanopowders” herein refers to both nanopowders and micropowders.

The invention is applied to liquid feedstocks. Where the following description refers to a liquid slurry comprising suspended nanopowders, it also includes a liquid precursor having dissolved solids such as salts. Such liquid precursors are handled in the same way in the invention as liquid slurries but when the precursor enters the plasma, some of the liquid evaporates and the dissolved solids react in the plasma to form the solid material which is sprayed from the torch, whereas with liquid slurries the liquid evaporates leaving the suspended solid particles.

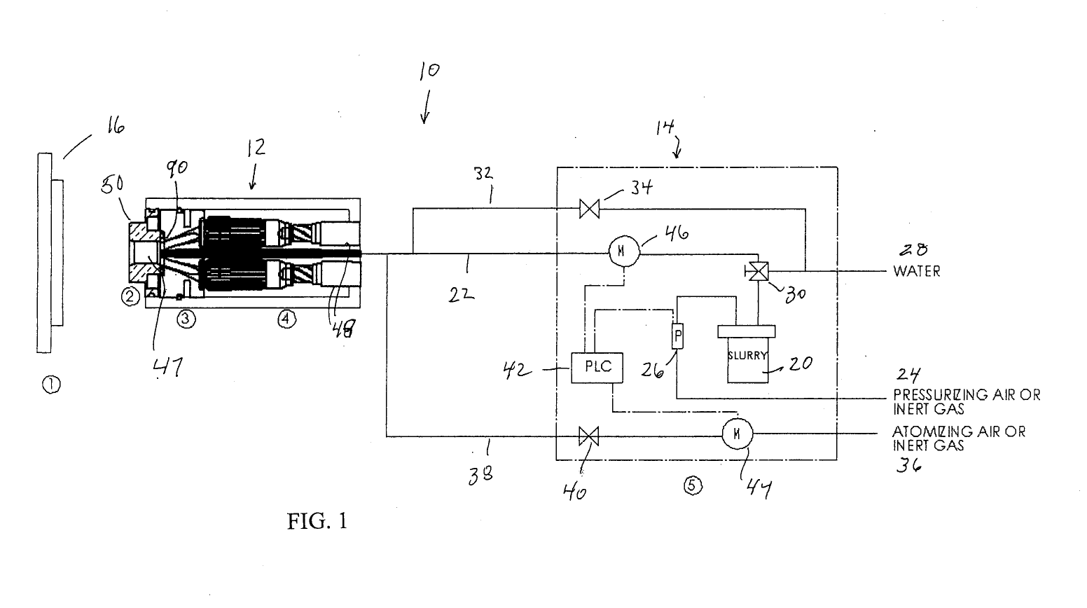

With reference to FIG. 1, the thermal spray system 10 comprises an axial injection torch 12 and a liquid feedstock delivery unit 14. The system directs a thermal spray at target substrate 16 to provide a coating on the surface of substrate 16.

Slurry delivery unit 14 comprises a source of feedstock slurry or liquid precursor 20 which is delivered to torch 12 via conduit 22. The slurry or precursor is delivered by a source of pressurizing air or inert gas 24 which is regulated by pressure regulator 26. A source of water 28 may provide water to the slurry conduit 22 to flush or clean conduit 22 either through valve 30 or conduit 32 and valve 34 downstream of the valve 30. A source of the atomizing air or inert gas is provided at 36 and provides the atomizing gas to the atomizer in torch 12 through conduit 38 and valve 40. A programmable logic controller 42 controls the process by monitoring flow meters 44, 46 and pressure regulator 26 and regulating the flow of slurry, and pressurizing and atomizing gas. A feedback control loop is thereby formed for controlling the liquid feedstock either with external pressure to the liquid reservoir or pump speed. Flow meter 44 is preferably a mass flow meter which meters the amount of atomizing gas and flow meter 46 is preferably a Coriolis or ultrasonic flow meter. In this way the flow of slurry is maintained constant through the interaction of the pressure regulator 26 and the mass flow meter 46, monitored by the controller 42. A Coriolis type flow meter is useful as it does not have any moving parts that could be worn by the solid particles in the suspension. It measures low flow rates for any density of the liquid and the uninterrupted flow passage though the metering device reduces the possibility of solids building up and causing obstructions.

Proper slurry preparation for plasma coating is important and each component has a substantial effect on the slurry deposition process. This involves the choice of solvent and additives. Preferably one obtains a well-dispersed and stable slurry with low viscosity for delivery to the plasma torch. The base of the slurry can be either water or an organic solvent such as aliphatic alcohols—ethanol, propanol, etc. In general, the slurry can be dispersed by an electrostatic, steric, or electrosteric stabilization mechanism. Ceramic particles must be uniformly dispersed in a binder-dispersant-solvent system. Factors which are taken into account include chemical compatibility of components, solubility of binder and additives, viscosity and electric receptivity of the multicomponent system. In the present system the gas-liquid ratio is optimized for the best atomizing effect.

As described below, the present system includes features to permit slurry feed to achieve dense coating structures, including atomization of the slurry feedstock; axial injection of the slurries into the plasma plume; evaporation of the liquid with simultaneous acceleration and melting of the solid particles; and sufficient particle momentum at impact with the substrate with optimum temperature and velocity to achieve the desired coating structure.

Axial injection torch 12 is preferably an Axial III™ plasma torch produced by Northwest Mettech Corp., of North Vancouver, Canada with a modified injector for slurry atomization and a nanoparticle slurry feeder. Axial injection provides that the slurry is fed by particle feed conduit 22 through convergence blank 90 into the center of three converging plasma jets 48, is atomized and then all the particles are fully entrained in the plasma flame in convergence area 47 before exiting from supersonic nozzle 50, described in further detail below. As a result, the coating process is less sensitive to the injection position, angle, and velocity compared to a ‘radial injection’ plasma torch. This simplifies the slurry plasma spray process. Due to the complex liquid-plasma interaction, a suitable adjusted slurry/atomization gas ratio, and atomizer configuration is critical for stable plasma, which otherwise will result in a deformed plasma flame, resulting non-uniform coating microstructures as well as injection problems such as pulsation and clogging. The Axial III™ torch 12 injects the atomized slurry feedstock axially in the direction of spray into the central core of the plasma overcoming the difficulties that arise when attempting to penetrate the plasma radially with fine particles or droplets.

The nanoparticle slurry feeder 14 is used to deliver nanoscale and fine micron powders in a slurry form into the plasma plume. It precisely feeds slurry mixtures using mass flow control of both slurry and atomizing gas to provide uniform atomizing at the injector. The slurry is preferably a fine powder slurry suspension in which the particle size is less than 5 microns. The precursor is preferably a dissolved salt solution in water or alcohol. The delivery of the solution is made to the axial injection torch 12 using mass flow computer control. Preferably the suspension is atomized within axial injection torch. Further a de Laval converging/diverging nozzle is used to generate supersonic flow. In this way dense oxide ceramics coatings can be produced which are strongly impervious to gas flow (H2) but may provide oxygen conductivity for Solid Oxide Fuel Cell (SOFC) applications or Oxygen Transport Membrane (OTM) applications.

In order to meet the coating specifications, it was discovered that by increasing the particle velocity during spraying, the coating would meet the required specifications. In seeking to increase the particle speed, it was found that the particle speed of the powder was being limited by the sonic barrier in the nozzle. The plasma gas was not able to exceed the speed of sound. To break this barrier, a converging-diverging nozzle based on the principles of de Laval was designed for the plasma gas flow.

A de Laval nozzle, also referred to as a convergent/divergent nozzle, CD nozzle or condi nozzle is a tube that is pinched in the middle, making an hourglass-shape. Such a nozzle is used as a means of accelerating the flow of a gas passing through it to a supersonic speed. An example of such a supersonic nozzle is disclosed in U.S. Pat. No. 5,782,414. The operation of such nozzles depends on the different properties of gases flowing at subsonic and supersonic speeds.

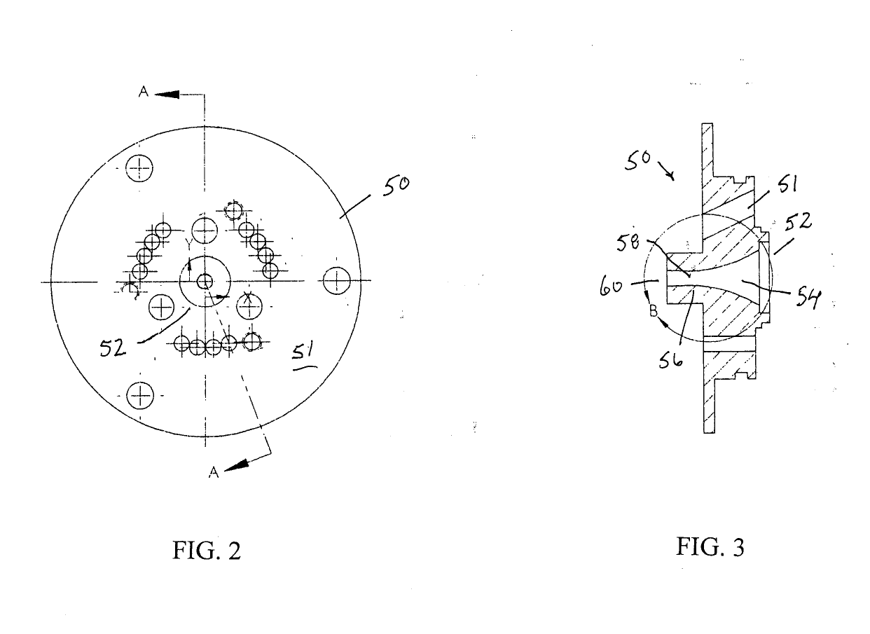

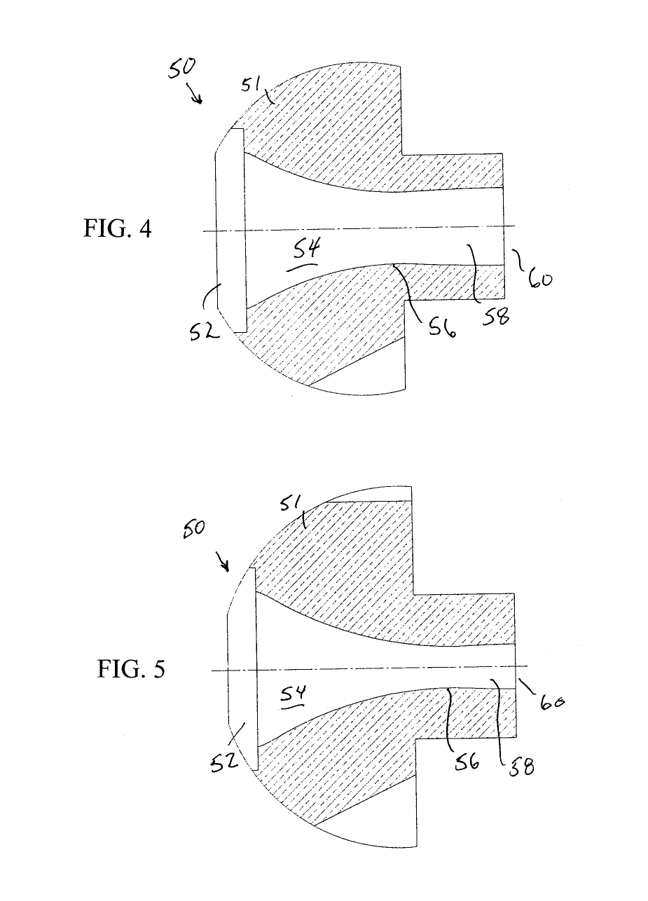

An example of a suitable convergent/divergent nozzle 50 is shown in FIG. 2-5. The body 51 of nozzle 50 has a central channel 54 with entrance 52 into which the converged plasma streams flow and which tapers inwardly to the narrowest point at throat 56, and then diverges in the area of 58 to the exit 60. The geometric shape of the central channel 54, 58 conforms to the requirements of a de Laval nozzle, and will vary depending on the composition, temperature and pressure of the gas flow and the volume of flow of the plasma. A range of geometries will still provide the desired de Laval effects for a given set of parameters. FIG. 4 illustrates a first geometry which is suitable for a first set of parameters and FIG. 5 illustrates a second geometry suitable for a second set of parameters.

After building, receiving, and testing nozzle 50, it was found that the plasma gas did exceed the sonic barrier. This was confirmed by the appearance of sonic shock discs in the plasma gas flow which were not previously present. Spraying the nanopowder through the nozzle resulted in increased particle speed. For example, a particle speed of 470 m/s was recorded, increased from 350 m/s without the supersonic nozzle, and particle speeds of up to 500 m/s can be obtained. The method of the invention is also useful however at subsonic particle speeds.

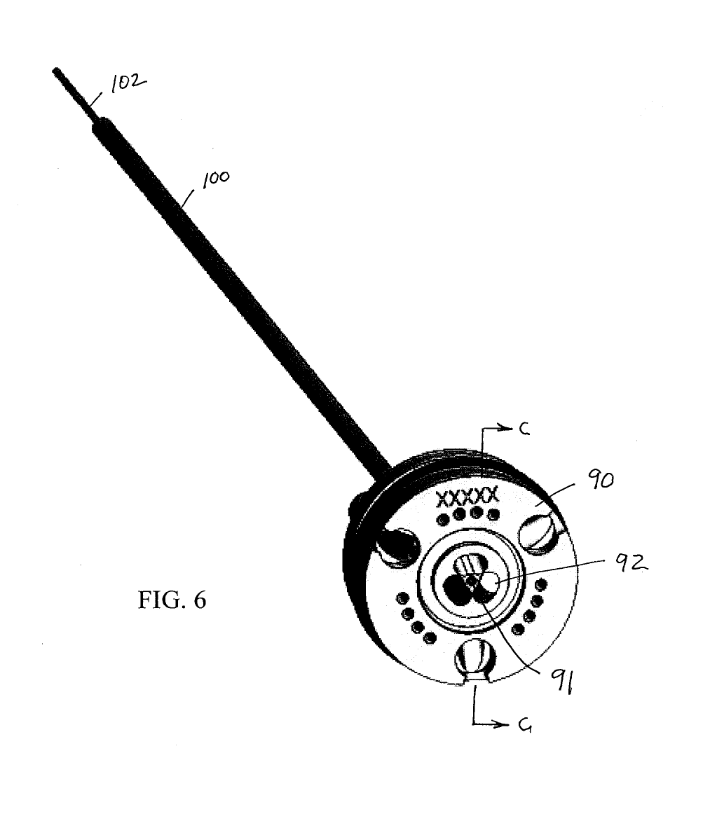

FIG. 6 illustrates the convergence blank 90 of axial injection torch 12. Convergence blank 90 has three converging channels 92 for the plasma sources, and central axial passage 91 for the liquid feed. The convergence area is shown in greater detail in FIG. 6A. Centering tabs 93 are provided on tube 102 to center it in the convergence blank. The liquid feedstock in the axial injection torch is injected axially in the center of the three plasma channels 92. The size of the injector is limited to the dimensions between the plasma channels. The manner of injection of the slurry is critical in preventing clogging. Clogging at the injector needs to be avoided in spraying liquid feedstocks to produce thermal spray coatings. Standard convergences may not provide enough cooling and may cause clogging at the injection point. A number of injector designs may be used to minimize clogging at the injector. The choice of design depends on the type of powder being sprayed or the type of coating one is trying to achieve. The injector design may affect the droplet size which will affect the properties of the thermal spray coating.

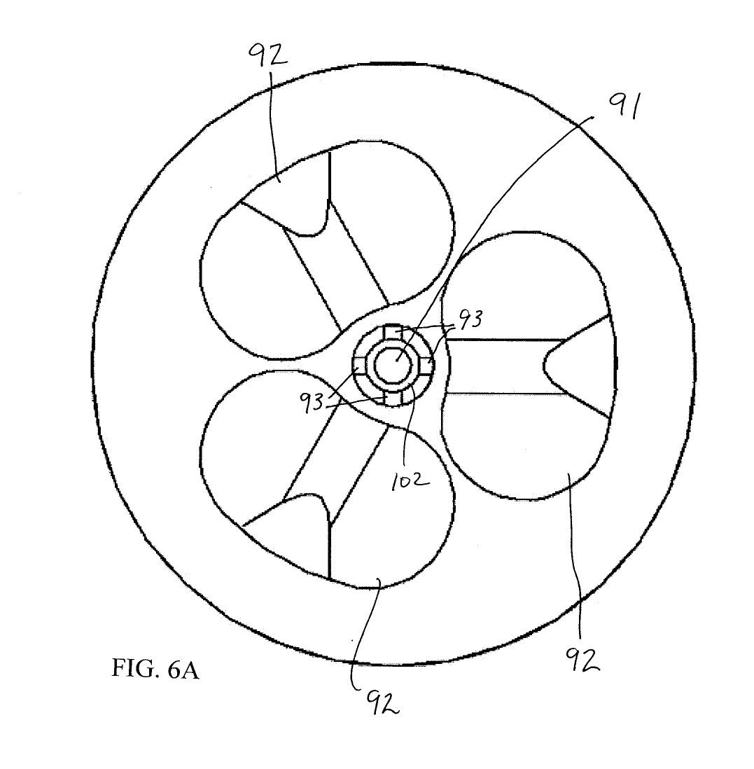

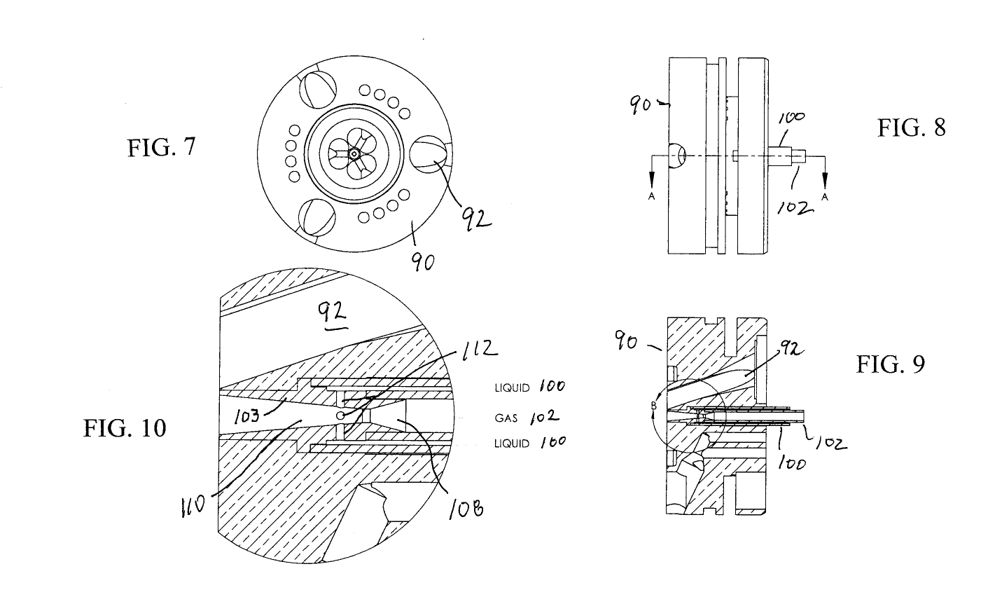

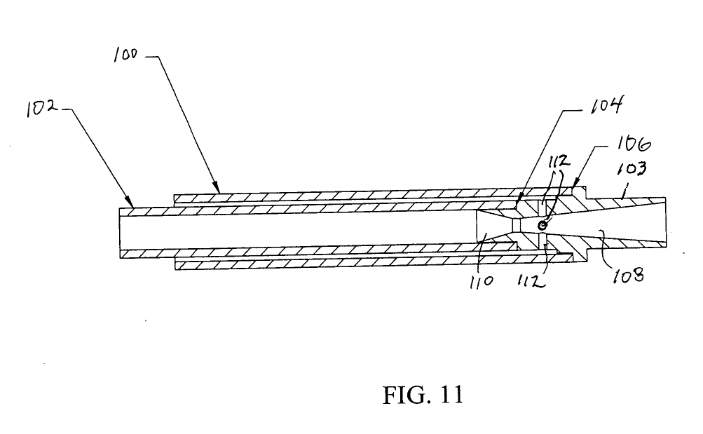

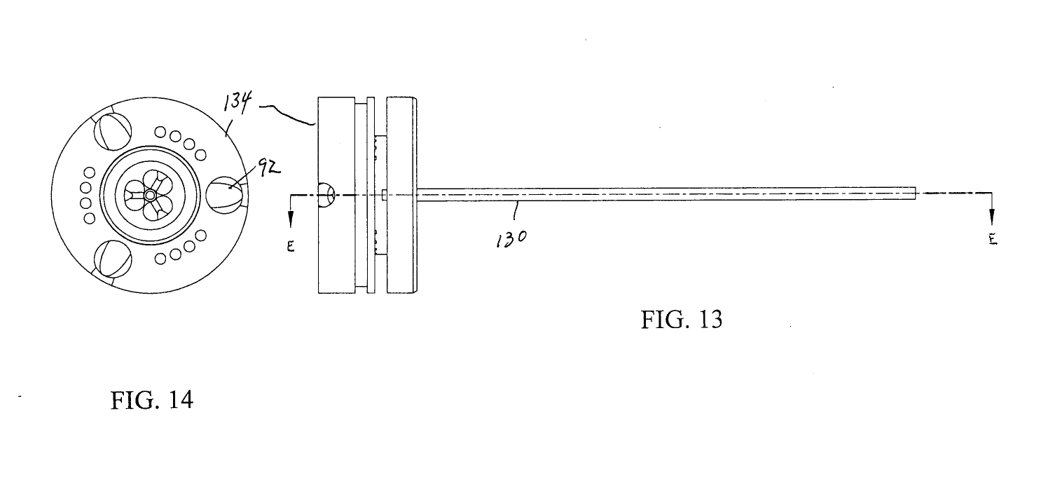

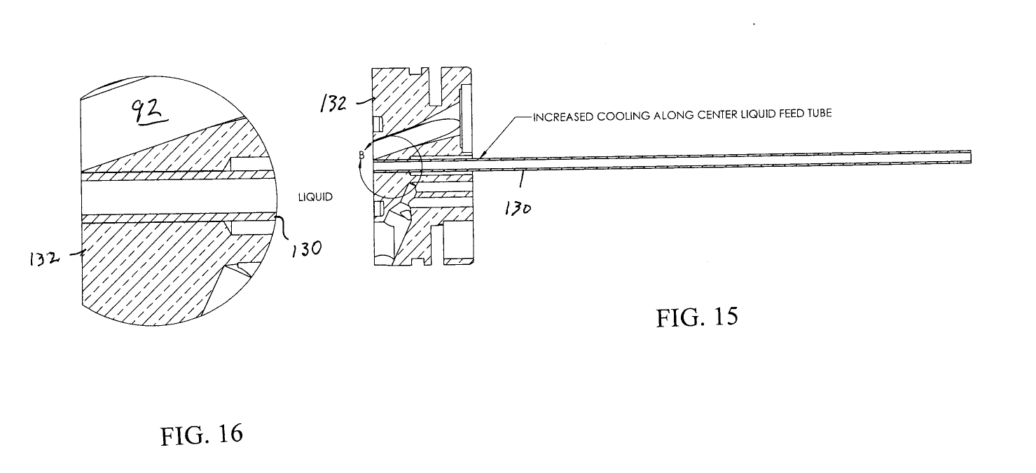

The injector may be a two fluid injector as shown in FIG. 7 through 12 or a liquid injector with increased cooling and no atomization as shown in FIG. 13-16. The embodiment of FIG. 7-11 has tube 100 for liquid on the outside and tube 102 for atomizing gas. For example the inside tube 102 may be ⅛″ in diameter and the outer tube 100 may be 3/16″ diameter. The tubes are lap welded to the injector 103 at 104, 106 and the injector is then brazed into the convergence blank. Gas passes through converging/diverging sections 108, 110 to speed up gas flow. Liquid enters radially through holes 112 after the gas has begun to diverge and is sheared by gas.

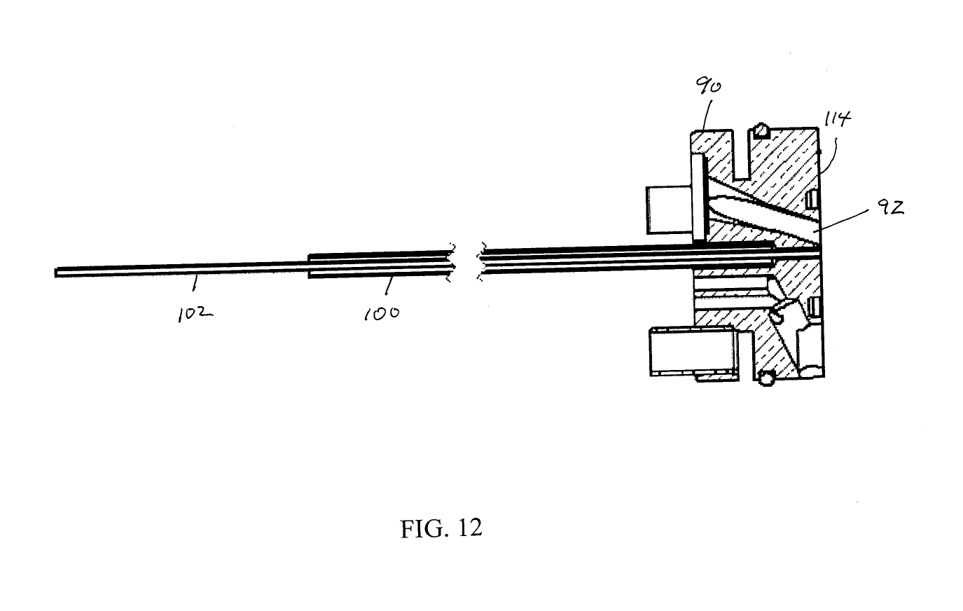

FIG. 12 illustrates a second style of two fluid injector in convergence blank 90. The injector is a tube-in-tube injector with tube 102 for liquid on the inside and tube 100 for gas on the outside. Liquid tube 102 is centered in bore 120 of blank 90 by centering tabs 93 as shown in FIG. 6A. The end of liquid tube 102 is flush with front 114 of the convergence blank 90 whereas the end of tube 100 butts against an interior surface of blank 90 at which point the gas in the interior of tube 100 communicates with the interior of tube 102 to atomize the liquid slurry. In a preferred embodiment the cross-sectional area of the outer gas tube 100 is 0.00402 square inches and the cross-sectional area of the inner liquid tube 102 is from 0.00238 square inches 0.0031 square inches. The preferred ratio of the cross-sectional flow area of liquid to gas is therefore from about 1/2 to 3/4 but can range from 1/3 to 1/1.

A liquid injector with increased cooling and no atomization is shown in FIG. 13-16. In this case there is liquid injection without atomizing gas. Liquid injection tube 130 carries the liquid and its end is flush with the face 132 of the convergence blank 134. Increased water cooling along the liquid feed tube 130 is provided to prevent clogging. The injection tube 130 may be brazed into the convergence blank 134 to increase heat transfer through the convergence blank 134.

### Example

A set-up was made to compare the density of YSZ coatings that were sprayed using the supersonic versus a regular ⅜ inch nozzle. The hardware parameters used were as follows. As the target substrate, sandblasted coupons were placed at 50 mm, 100 mm, then 75 mm. As the cooling gas, compressed air was used. The atomizer used was a 1/16″ tube in tube, with the liquid on the inner tube. The slurry feeder used a 1/16″ feed line. The torch raster speed was 1000 mm/s with the distance between rasters 4 mm. The liquid feed rate was 1.2 kg/hr. Plasma parameters were varied according to the nozzle used, and were as follows. The balance of the gas in each case was Argon.

| | | Super Sonic |
|---|---|---|
| Nozzle | ⅜″ | (300 lpm) |
| Total Gas | 180 lpm | 225 lpm |
| Flow | | |
| Nitrogen | 45% | 10% |
| Hydrogen | 10% | 17% |
| Current | 190 A | 230 A |

Spray runs were made using both the regular and supersonic nozzles, making 30 or 40 passes, with YSZ precursor and slurry. During the spraying of YSZ precursor with the supersonic nozzle, the spray rate was reduced to 0.7 kg/hr.due to the increased pressure in the super sonic nozzle. The size of the supersonic nozzle used was 300 litres per minute. The results showed that the densest coatings occurred when the supersonic nozzle was used with YSZ precursor or YSZ slurry.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within its true spirit and scope.

What is claimed is:

1. A thermal spray system for producing coatings on a substrate from a liquid feedstock comprising:
i) an axial injection thermal spray torch for generating a plasma spray from a plurality of plasma streams which converge in a convergence area within said torch;
ii) a liquid feedstock delivery means for delivering a controlled flow of liquid feedstock to said axial injection thermal spray torch for axial injection into said plurality of plasma streams in said convergence area; and
iii) wherein said torch comprises a convergent/divergent nozzle downstream of said convergence area through which said plasma spray is discharged.

2. The system of claim 1 wherein said thermal spray torch is provided with an atomizer for atomizing said liquid feedstock prior to injection into said plurality of plasma streams.

3. The system of claim 2 wherein said atomizer comprises an atomizing injector comprising a two fluid flow injector with concentric inner liquid flow and outer atomizing gas flow.

4. The system of claim 1 wherein said liquid feedstock is a liquid slurry of suspended nanopowders or a liquid precursor.

5. The system of claim 1 wherein said liquid feedstock delivery means comprises an electronic controller and a mass flow meter.

6. The system of claim 1 wherein said convergent/divergent nozzle comprises a supersonic nozzle.

7. The system of claim 1 wherein said convergent/divergent nozzle comprises a subsonic nozzle.

8. The system of claim 1 wherein said liquid feedstock delivery means comprises:
i) a liquid reservoir with means for pressure control;
ii) flow metering means for measuring the flow of the liquid feedstock;
iii) feedback control loop means for controlling the liquid feedstock with external pressure to the liquid reservoir; and
iv) means for providing a cleaning cycle.

9. The system of claim 1 where said liquid feedstock delivery means comprises:
i) a liquid reservoir connected to a pump;
ii) flow metering means for measuring the flow of the liquid feedstock;
iii) feedback control loop means to control liquid feed flow with pump speed;
iv) means for providing a cleaning cycle.

10. A method for producing coatings on a substrate from a liquid feedstock, the method comprising:
i) providing a) an axial injection thermal spray torch for generating a plasma spray from a plurality of plasma streams which converge in a convergence area within said torch wherein said torch comprises a convergent/divergent nozzle downstream of said convergence area through which said plasma spray is discharged; and b) a liquid feedstock delivery means for delivering a controlled flow of liquid feedstock to said axial injection thermal spray torch for axial injection into said plurality of plasma streams in said convergence area; and
ii) delivering a controlled flow of liquid feedstock to the axial injection thermal spray torch and thereby producing a plasma spray of coating particles discharged onto said substrate through said convergent/divergent nozzle.

11. The method of claim 10 wherein said torch is provided with an atomizer for atomizing the liquid feedstock prior to injection into said plurality of plasma streams in said convergence area.

12. The method of claim 10 wherein said liquid feedstock is a liquid slurry of suspended nanopowders or a liquid precursor.

13. The method of claim 10 wherein said liquid feedstock delivery means comprises an electronic controller and a mass flow meter.

14. A thermal spray system for producing coatings on a substrate from a liquid feedstock comprising:
i) an axial injection thermal spray torch for generating a plasma spray from a plurality of plasma streams which converge in a convergence area within said torch;
ii) a liquid feedstock delivery means for delivering a controlled flow of liquid feedstock to said axial injection thermal spray torch for axial injection into said plurality of plasma streams in said convergence area; and
iii) wherein said torch comprises an atomizing injector for atomizing said liquid feedstock delivery prior to axial injection into said plurality of plasma streams in said convergence area, and a convergent/divergent nozzle downstream of said convergence area through which said plasma spray is discharged.

15. The system of claim 14 wherein said atomizing injector comprises a two fluid flow injector with concentric inner liquid flow and outer atomizing gas flow.

16. The system of claim 15 wherein said atomizing injector has a ratio of cross-sectional area of the liquid flow to atomizing gas flow is in the range of from 1:3 to 1:1.

17. The system of claim 14 wherein said liquid feedstock delivery means comprises:
i) a liquid reservoir with means for pressure control;
ii) flow metering means for measuring the flow of the liquid feedstock;
iii) feedback control loop means for controlling the liquid feedstock with external pressure to the liquid reservoir; and
iv) means for providing a cleaning cycle.

18. The system of claim 14 where said liquid feedstock delivery means comprises:
i) a liquid reservoir connected to a pump;
ii) flow metering means for measuring the flow of the liquid feedstock;
iii) feedback control loop means to control liquid feed flow with pump speed;
iv) means for providing a cleaning cycle.

19. The system of claim 14 wherein said converging/diverging nozzle comprises a supersonic nozzle.

20. The system of claim 14 wherein said converging/diverging nozzle comprises a sub-sonic nozzle.

21. A coating consisting of Yttria Stabilized Zirconia made using the system of claim 1 for use in a Solid Oxide Fuel Cell requiring low gas permeability for an Oxygen Transport Membrane application.

22. A coating consisting of Yttria Stabilized Zirconia made according to the method of claim 10 for use in a Solid Oxide Fuel Cell requiring low gas permeability for an Oxygen Transport Membrane application.
